(19) United States
(12) Patent Application Publication
(10) Pub. No.: US 2020/0333060 A1
(43) Pub. Date: Oct. 22, 2020

(54) REFRIGERATION MECHANISM AND COLD STORAGE WAREHOUSE

(71) Applicant: WUYI UNIVERSITY, Jiangmen (CN)

(72) Inventor: Min WU, Jiangmen (CN)

(21) Appl. No.: 16/519,435

(22) Filed: Jul. 23, 2019

(30) Foreign Application Priority Data
Apr. 22, 2019 (CN) 201910324182.0

(51) Int. Cl. F25D 13/00; B67D 7/04; F25D 17/00

(52) U.S. Cl. CPC F25D 13/00; B67D 7/04; F25D 2300/00; F25B 2327/001; F25D 17/005

(57) ABSTRACT

The present disclosure discloses a refrigeration mechanism and a cold storage warehouse. The refrigeration mechanism includes a compressor, configured to compress a refrigerant, so that the refrigerant flows in a pipeline; a condenser, configured to absorb heat of the refrigerant conveyed by the compressor, so that the gasified refrigerant becomes a liquid; an expansion valve, configured to perform throttling and pressure reduction to the liquid refrigerant; an evaporator, configured to exchange heat with outside air by using the refrigerant to implement refrigeration; and a driving component. The driving component includes an external combustion engine for driving the compressor and a material supply mechanism for providing fuel for the external combustion engine. Therefore, use of the electrical energy is reduced and the cost is reduced.

### FIELD

The present disclosure relates to the technical field of cold storage, and in particular, to a refrigeration mechanism and a cold storage warehouse.

### INTRODUCTION

At present, an unmarketable condition often occurs in a harvest season. A lot of fruits will be rotted quickly if failing to sell timely. Thus, a basement having an air conditioner device is generally constructed as a storage space in a rural area. However, the basement has a huge space, and the electric quantity consumed to cool the basement with such a huge space is very high; and as a result, the cost is too high.

### SUMMARY

The present disclosure is intended to solve at least one of the above-mentioned technical problems in the related art to a certain extent. To this end, the present disclosure discloses a refrigeration mechanism and a cold storage warehouse configured to reduce the cost.

The technical solutions adopted by the present disclosure to solve the technical problems include the following.

A refrigeration mechanism may include a compressor, configured to compress a refrigerant, so that the refrigerant flows in a pipeline; a condenser, configured to absorb heat of the refrigerant conveyed by the compressor, so that the gasified refrigerant becomes a liquid; an expansion valve, configured to perform throttling and pressure reduction to the liquid refrigerant; an evaporator, configured to exchange heat with outside air by using the refrigerant to implement refrigeration; and a driving component, including an external combustion engine for driving the compressor and a material supply mechanism for providing fuel for the external combustion engine; the evaporator is disposed in an air box, the air box is provided with an air inlet pipe and an air outlet pipe, the air outlet pipe is disposed at a bottom of the air box, and the air inlet pipe is disposed on an upper portion of the air box; and the compressor, the condenser, the expansion valve and the evaporator are sequentially connected via the pipeline to form a cooling loop.

Beneficial effects include the following: branches and/or twigs of a tree (e.g., of a fruit tree) are used to provide fuel for the external combustion engine, so that heat energy is converted into mechanical energy to drive the compressor; and electrical energy is only provided as driving energy for an igniter of the external combustion engine. Therefore, use of electrical energy is reduced and the cost is reduced.

The material supply mechanism may include:

a hopper, configured to feed the fuel; and

a mixer (e.g., a blender or stirrer), configured to crush or smash the fuel, breaking the fuel into small pieces;

the hopper is disposed above the mixer;

a material conveying pipe is disposed between the mixer and the external combustion engine; and

the material conveying pipe is inclined downward from the mixer to the external combustion engine.

The branches are put into the hopper for storage. When needed, the branches enter the mixer and are smashed into small pieces (e.g., chunks or granules) by the mixer; and the granules enter the external combustion engine via the material conveying pipe as the fuel, thus continuously driving the external combustion engine to work.

The external combustion engine may be connected with the compressor via a shaft coupler and drives the compressor to work.

Further, the material conveying pipe may be a circular pipe, and an exhaust fan may be disposed in an inner cavity of the circular pipe.

Further, a spiral air pipe may be disposed in the air box; the evaporator is disposed at a center of the spiral air pipe; and the air inlet pipe and the air outlet pipe are respectively connected to two ends of the spiral air pipe. By increasing an area for heat exchange between the air in the air box and the refrigerant, heat is exchanged more thoroughly.

A cold storage warehouse may include a basement and the refrigeration mechanism in any one of the foregoing embodiments; the basement is sealed; the basement is provided with an air inlet and an air outlet; the air inlet pipe communicates with the air outlet; and the air outlet pipe communicates with the air inlet.

Beneficial effects include the following: pieces of wood (e.g., branches of a fruit tree) are used to provide fuel for the external combustion engine, so that heat energy is converted into mechanical energy to drive the compressor; and electrical energy is only provided as driving energy for an igniter of the external combustion engine. Therefore, use of the electrical energy is reduced and the cost is reduced.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

The present disclosure will be further described below in conjunction with the accompanying drawings and embodiments.

FIG. 1 is a schematic structural diagram of an installation of the present disclosure; and

FIG. 2 is a schematic diagram of installation and connection between a mixer and an external combustion engine of the present disclosure.

### DETAILED DESCRIPTION

Various aspects and examples of a refrigeration system and cold storage warehouse, as well as related methods, are described below and illustrated in the associated drawings. Unless otherwise specified, a refrigeration system and warehouse in accordance with the present teachings, and/or their various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

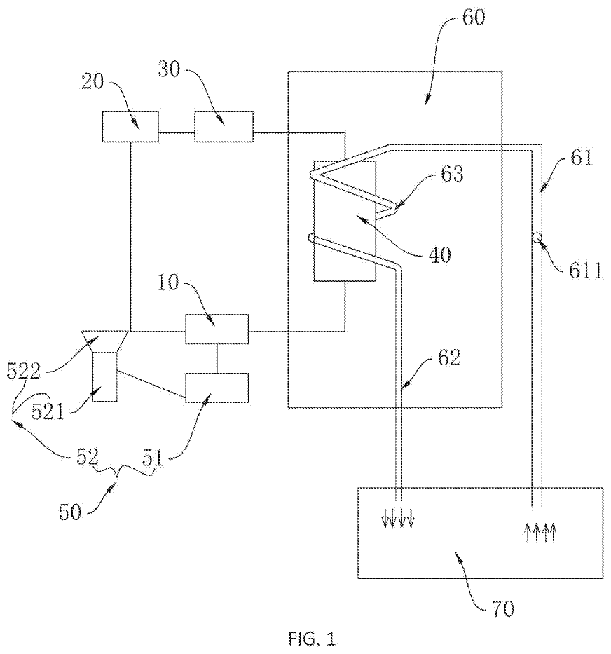

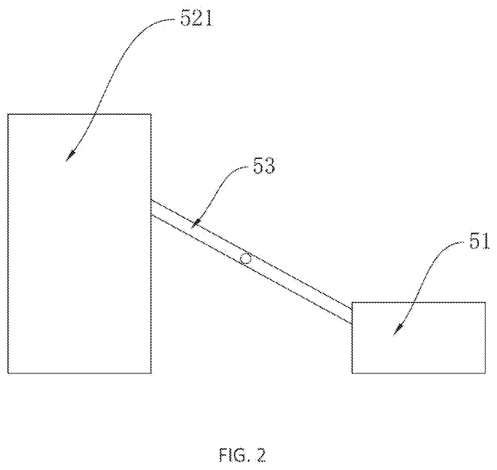

Referring to FIG. 1 and FIG. 2, a refrigeration mechanism provided by the present disclosure includes a compressor 10, configured to compress a refrigerant, so that the refrigerant flows in a pipeline; a condenser 20, configured to absorb heat of the refrigerant conveyed by the compressor 10, so that the gasified refrigerant becomes a liquid; an expansion valve 30, configured to perform throttling and depressurization to the liquid refrigerant; an evaporator 40, configured to exchange heat with outside air by using the refrigerant to implement refrigeration; and a driving component 50, including an external combustion engine 51 for driving the compressor 10; and a material supply mechanism 52 for providing fuel for the external combustion engine 51.

The evaporator 40 is disposed in an air box 60. The air box 60 is provided with an air inlet pipe 61 and an air outlet pipe 62. The air outlet pipe 62 is disposed at a bottom of the air box 60, and the air inlet pipe 61 is disposed on an upper portion of the air box 60. The compressor 10, the condenser 20, the expansion valve 30, and the evaporator 40 are sequentially connected via the pipeline to form a cooling loop.

The refrigerant is gasified under the compression of the compressor 10 and is conveyed to the condenser 20 for cooling, so that the refrigerant in a gaseous state is liquefied and cooled. The cooled refrigerant enters the expansion valve 30, the expansion valve 30 performs the throttling and depressurization to the refrigerant, and at last the refrigerant enters the evaporator 40. In the air box 60, the outside air enters from the air inlet pipe 61 and exchanges heat with the refrigerant in the evaporator 40 to cool the outside air, and the cold air sinks and is discharged out of the air box 60 with the air outlet pipe 62.

Branches or twigs (e.g., of a fruit tree) are used to provide fuel for the external combustion engine 51, so that heat energy is converted into mechanical energy to drive the compressor 10. Electrical energy is only provided as driving energy for an igniter of the external combustion engine 51. Therefore, use of the electrical energy is reduced and the cost is reduced.

The material supply mechanism 52 includes: a hopper 522, configured to feed the fuel; and a mixer 521, configured to crush the fuel. The hopper 522 is disposed above the mixer 521. A material conveying pipe 53 is disposed between the mixer 521 and the external combustion engine 51, and the material conveying pipe 53 is inclined downward from the mixer 521 to the external combustion engine 51.

The branches of the fruit tree are put into the hopper 522 for storage. When appropriate, the branches enter the mixer 521 and are granularized by the mixer 521. The granules enter the external combustion engine 51 via the material conveying pipe 53 as the fuel, thus continuously driving the external combustion engine 51 to work. In some embodiments, the material conveying pipe 53 is a circular pipe, and an exhaust fan is disposed in an inner cavity of the circular pipe.

As a further improvement of the above technical solutions, the external combustion engine 51 is connected with the compressor 10 via a shaft coupler and drives the compressor 10 to work.

In some embodiments, a spiral air pipe 63 is disposed in the air box 60. The evaporator 40 is disposed at a center of the spiral air pipe 63, and the air inlet pipe 61 and the air outlet pipe 62 are respectively connected to two ends of the spiral air pipe 63. By increasing an area for heat exchange between the air in the air box 60 and the refrigerant, heat is exchanged more thoroughly.

A cold storage warehouse of the present disclosure includes a basement and the refrigeration mechanism. The basement is sealed, and is provided with an air inlet and an air outlet. The air inlet pipe 61 communicates with the air outlet, and the air outlet pipe 62 communicates with the air inlet.

When in use, the external combustion engine 51 is connected with a commercial power supply and is powered by the commercial power supply. Moreover, the mixer 521 is used to smash branches by stirring, and the branches form a granular fuel and are then input to the external combustion engine 51 as the fuel. By driving an igniter in the external combustion engine 51, the fuel is combusted, and the external combustion engine 51 is started to drive the compressor 10. Therefore, the whole cooling loop works continuously and the air in the air box is cooled continuously. Preferably, the air inlet pipe 61 is provided with a draft fan configured to urge hot air in the basement 70 to the air box for cooling, and the cooled cold air enters the basement 70 via the air outlet pipe 62, thereby guaranteeing the temperature of the basement 70.

The branches of the fruit tree are used to provide fuel for the external combustion engine 51, so that heat energy is converted into mechanical energy to drive the compressor 10; and electrical energy is only provided as driving energy for an igniter of the external combustion engine 51. Therefore, use of the electrical energy is reduced and the cost is reduced.

The above specific structures and dimensional data are specific descriptions on preferred embodiments of the present disclosure. However, the present disclosure is not limited to the above embodiments. Those skilled in the art may further make various equivalent variations or replacements without departing from the spirit of the present disclosure, and these equivalent variations or replacements all are included in a scope defined by the claims of the present application.

### Conclusion

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

What is claimed is:

1. A refrigeration mechanism, comprising:
a compressor, configured to compress and convey a gasified refrigerant, such that the gasified refrigerant flows in a pipeline;
a condenser, configured to absorb heat of the gasified refrigerant conveyed by the compressor, such that the gasified refrigerant becomes a liquid refrigerant;
an expansion valve, configured to perform throttling and depressurization of the liquid refrigerant;
an evaporator, configured to exchange heat with outside air using the refrigerant, such that the liquid refrigerant is evaporated to implement refrigeration; and
a driving component, comprising an external combustion engine configured to drive the compressor and a material supply mechanism configured to provide fuel to the external combustion engine;
wherein the evaporator is disposed in an air box, the air box is provided with an air inlet pipe disposed on an upper portion of the air box and an air outlet pipe disposed at a bottom of the air box; and
wherein the compressor, the condenser, the expansion valve, and the evaporator are sequentially connected via the pipeline to form a cooling loop.

2. The refrigeration mechanism according to claim 1, wherein the material supply mechanism comprises:
a hopper, configured to feed the fuel; and
a mixer, configured to crush the fuel;
wherein the hopper is disposed above the mixer, a material conveying pipe is disposed between the mixer and the external combustion engine, and the material conveying pipe is inclined downward from the mixer to the external combustion engine.

3. The refrigeration mechanism according to claim 2, wherein the material conveying pipe is a circular pipe, and an exhaust fan is disposed in an inner cavity of the circular pipe.

4. The refrigeration mechanism according to claim 2, wherein the external combustion engine is connected with the compressor via a shaft coupler and drives the compressor to work.

5. The refrigeration mechanism according to claim 1, wherein the external combustion engine is connected with the compressor via a shaft coupler and drives the compressor to work.

6. A cold storage warehouse, comprising a basement and the refrigeration mechanism of claim 1, wherein the basement is sealed; the basement is provided with an air inlet and an air outlet; the air inlet pipe communicates with the air outlet; and the air outlet pipe communicates with the air inlet.

7. The refrigeration mechanism according to claim 1, wherein a spiral air pipe is disposed in the air box; the evaporator is disposed at a center of the spiral air pipe; and the air inlet pipe and the air outlet pipe are respectively connected to two ends of the spiral air pipe.

8. A cold storage warehouse, comprising a basement and the refrigeration mechanism of claim 2, wherein the basement is sealed; the basement is provided with an air inlet and an air outlet; the air inlet pipe communicates with the air outlet; and the air outlet pipe communicates with the air inlet.
